(19) United States
(12) Patent Application Publication
(10) Pub. No.: US 2017/0171376 A1
(43) Pub. Date: Jun. 15, 2017

(54) METHOD AND ELECTRONIC DEVICE FOR DISPLAYING INFORMATION

(71) Applicants: LE HOLDINGS (BEIJING) CO., LTD., Beijing (CN); LE SHI INTERNET INFORMATION & TECHNOLOGY CORP., BEIJING, Beijing (CN)

(72) Inventors: Yanhong CHU, Beijing (CN); Panying NIU, Beijing (CN); Guojian LI, Beijing (CN)

(21) Appl. No.: 15/241,635

(22) Filed: Aug. 19, 2016

Related U.S. Application Data
(63) Continuation of application No. PCT/CN2016/089282, filed on Jul. 7, 2016.

(30) Foreign Application Priority Data
Dec. 15, 2015 (CN) 201510938147.X

(51) Int. Cl. H04M 1/725; H04L 12/861; H04L 12/26; H04L 12/58; H04L 29/06

(52) U.S. Cl. CPC H04M 1/72547; H04L 51/16; H04L 67/42; H04L 51/04; H04L 43/16; H04L 49/9047

(57) ABSTRACT

A method for displaying information and an electronic device, wherein the method includes: receiving a new information; acquiring a level of the new information; acquiring a current state of an information display window; and determining a display mode of the new information for displaying the new information according to the level of the new information and the current state of the information display window, wherein the display mode comprises a direct display mode, a waiting in queue mode and a discarding mode. In the embodiments of the disclosure, levels are assigned to information; after a terminal equipment receives a piece of new information, the terminal equipment will no longer directly display the new information, instead, it will determine a display mode based on the information level and the state of the information display window. Thus, some unimportant information may be filtered off while display of important information is guaranteed, and an overall amount of information to be displayed is reduced; thereby it may be avoided that the display of information occupies many system resources, and the processing load on the terminal equipment may be reduced.

### CROSS-REFERENCE TO RELATED APPLICATION

This application is a continuation of International PCT Patent Application No. PCT/CN2016/089282, filed Jul. 7, 2016 (attached hereto as an Appendix), and claims benefit/priority of Chinese patent application No. 201510938147.X, filed with the State Intellectual Property Office of China on Dec. 15, 2015, which are all incorporated herein by reference in entirety.

### TECHNICAL FIELD

The present disclosure relates to the field of communication technologies, and in particular, to a method for displaying information and an electronic device.

### BACKGROUND

Some APPs (application software), for example, video live broadcast APP, installed on a terminal equipment such as a mobile phone and a tablet computer, etc., usually carry an on-line chat function, and a user may send real-time information on a chat window to express his/her own opinion and participate in discussion on various issues.

Generally, the information received by a terminal equipment will be displayed on a chat window, and generally, in order to attain a good display effect, animation rendering will be performed for each information during display, that is, each information will be played in the form of animation. However, as a result, the display of information will occupy many system resources, and the terminal equipment will experience a large processing load, which tends to cause a phenomenon such as page display halt and system down, etc.

### SUMMARY

In order to overcome the problem in the prior art, the present disclosure provide a method and an electronic device for displaying information, thereby solving the problem that the load on terminal equipment is too large during the display of real-time information.

According to a first aspect of the embodiments of the present disclosure, there provides a method for displaying information, including:

receiving a new information;

acquiring a level of the new information;

acquiring a current state of an information display window; and

determining a display mode of the new information for displaying the new information according to the level of the new information and the current state of the information display window, wherein the display mode includes a direct display mode, a waiting in queue mode and a discarding mode.

According to a second aspect of the embodiments of the present disclosure, there provides a non-transitory computer-readable storage medium storing computer executable instructions that are configured to carry out any one of the above method for displaying information according to the disclosure.

According to a third aspect of the embodiments of the present disclosure, there provides an electronic device that includes: at least one processor and a memory communicably connected with the at least one processor, wherein instructions that are executable by the at least one processor are stored in the memory, and the instructions are configured to carry out any one of the above method for displaying information according to the disclosure.

### BRIEF DESCRIPTION OF THE DRAWINGS

One or more embodiments are illustrated by way of example, and not by limitation, in the figures of the corresponding accompanying drawings, wherein elements having the same reference numeral designations represent like elements throughout. The drawings are not to scale, unless otherwise disclosed.

FIG. 1 is a flow chart of a method for displaying information according to an embodiment of the disclosure;

FIG. 2 is a flow chart of a method for displaying information according to an embodiment of the disclosure;

FIG. 3 is a flow chart of a method for displaying information according to an embodiment of the disclosure;

FIG. 4 is a schematic diagram showing a receive of information according to an embodiment of the disclosure;

FIG. 5 is a schematic diagram showing an information display window according to an embodiment of the disclosure;

FIG. 6 is a block diagram of an electronic device for displaying information according to an embodiment of the disclosure;

FIG. 7 is a block diagram of an electronic device for displaying information according to an embodiment of the disclosure;

FIG. 8 is a block diagram of an electronic device for displaying information according to an embodiment of the disclosure; and

FIG. 9 is a diagram illustrating a hardware structure of an apparatus for carrying out the method for displaying information according to an embodiment of the disclosure.

### DETAILED DESCRIPTION

Exemplary embodiments, of which the examples are shown in the drawings, will be illustrated in detail here. When the description below refers to the drawings, the same numeral in different drawings represents the same or similar element, unless otherwise expressed. The implementation modes described in the following exemplary embodiments do not represent all the implementation modes consistent with the disclosure. Instead, they are merely examples of the electronic device and the method consistent with some aspects of the disclosure as described in detail in the claims appended.

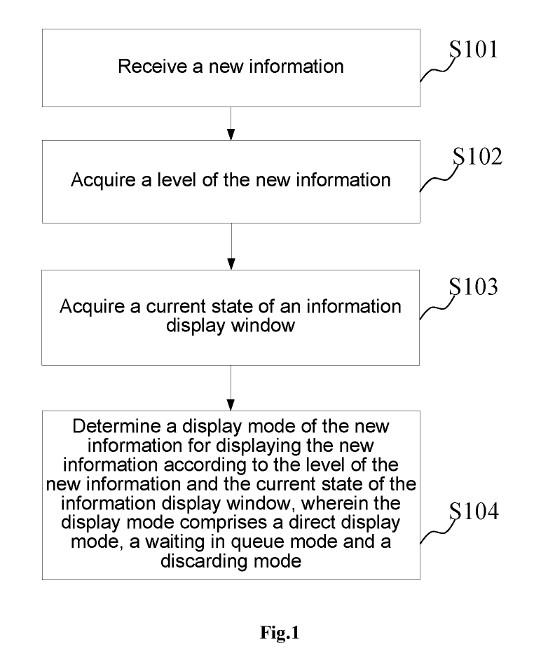

FIG. 1 is a flow chart of a method for displaying information according to an embodiment of the disclosure. The method may be applied to a terminal equipment such as a mobile phone and a tablet computer, etc.

Referring to FIG. 1, the method may include:

In Step S101: a new information is received.

Taking a mobile phone as an example, a user may use a certain video player APP on the mobile phone to watch a video such as a direct-broadcast program; the user may participate in a chat interaction during watching, and a piece of new information may be received during chatting.

In Step S102: the level of the new information is acquired.

For example, the levels could be divided into a first level, a second level and a third level, and the corresponding priorities thereof reduce gradually. It will not be limited in this embodiment how to acquire the level of the new information; for example, the level may be determined according to the information source, or be determined according to a feature carried by the information itself, etc.

In Step S103: the current state of an information display window is acquired.

For example, the state of the information display window may be the state of a buffer pool. Because sometimes the terminal equipment may receive too much information in a short time period and cannot display all of the information in time, a buffer pool will be usually provided for the information display window, such that an information received first enters the buffer pool and then is displayed on the window. In the prior art, all the information received will be displayed by the terminal equipment, and the information will be buffered for a final display even if the buffer pool is full. However, in this embodiment, it will distinguish between informations based on the levels thereof, and when the buffer pool is full, some unimportant information may be directly discarded.

Additionally, it should be pointed out that, the order of the above three steps is not limited except that S102 must be after S101. FIG. 1 is only an example, and in other embodiments, for example, the current state of the information display window may be acquired first, and then a piece of new information is received, and so on.

In Step S104: a display mode of the new information is determined for displaying said new information according to the level of the new information and the current state of the information display window, wherein the display mode includes a direct display mode, a waiting in queue mode and a discarding mode.

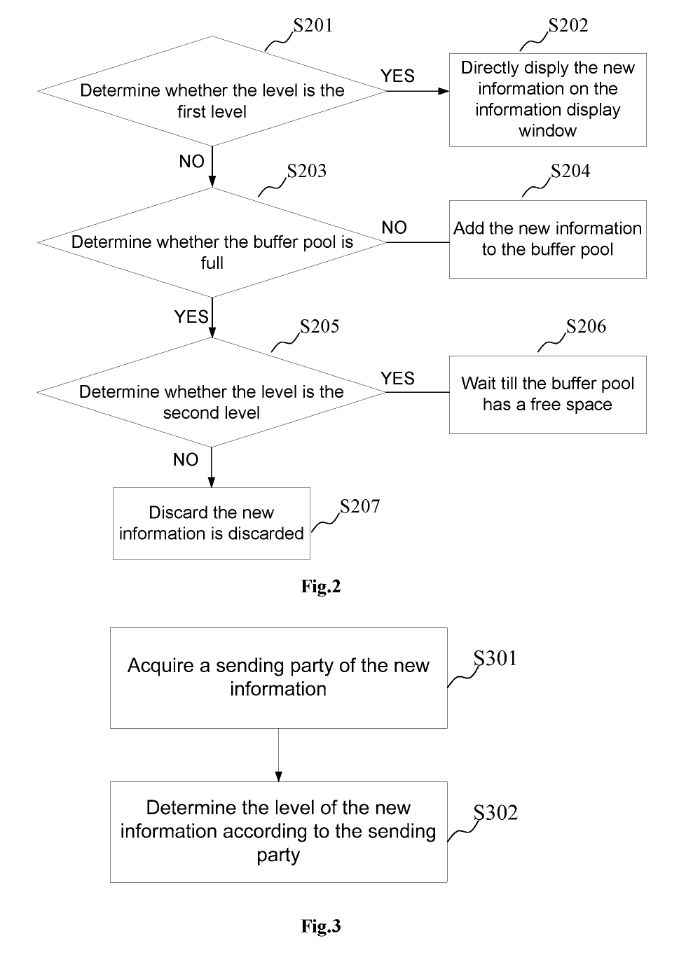

In this embodiment or in some other embodiments of the disclosure, the levels include a first level, a second level and a third level; and the current state of the information display window includes the buffer pool state of the information display window; at this point, referring to FIG. 2, the step of determining the display mode of the new information according to the level of the new information and the current state of the information display window may include:

in Step S201: it is determined whether the level is the first level. If it is the first level, it turns to Step S202, and if it is not the first level, it turns to Step S203;

in Step S202: the new information is directly displayed on the information display window;

in Step S203: it is determined whether the buffer pool is full. If the buffer pool is not full, it turns to Step S204, and if the buffer pool is full, it turns to Step S205;

in Step S204: the new information is added to the buffer pool. The buffer pool may contain a message queue, and the new information waits in the queue and is finally displayed;

in Step S205: it is determined whether the level is the second level. If it is the second level, it turns to Step S206, and if it is not the second level (i.e., the third level), it turns to Step S207;

in Step S206: it waits till the buffer pool has a free space, and the new information may be then added to the buffer pool for final display;

In Step S207: The new information is discarded.

Referring to FIG. 3, in this embodiment or in some other embodiments of the disclosure, the step of acquiring the level of the new information includes:

In Step S301: a sending party of the new information is acquired; and

In Step S302: the level of the new information is determined according to the sending party.

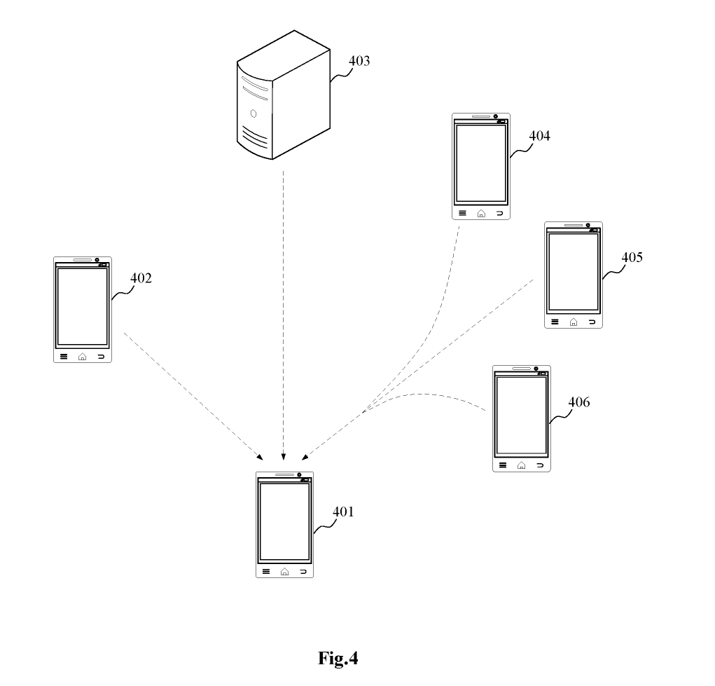

As an example, reference may be made to FIG. 4. In FIG. 4, 401 represents a mobile phone of the current user, 402 represents a mobile phone of a guest of a direct-broadcast program, 403 represents a server of the program providing party, and 404-406 represent mobile phones of other ordinary users. During play of the direct-broadcast program, the mobile phone 401 may receive discussion informations on the program from a guest and other users (strictly speaking, such informations are usually forwarded by a server), and the mobile phone 401 may also receive broadcast informations from the server, for example, “this program will be re-broadcasted at xx on xx”, etc. The mobile phone 401 may distinguish between the levels of each information according to different sending parties of the information.

In this embodiment or in some other embodiments of the disclosure, the step of determining the level of the new information according to the sending party may include:

determining the level as the first level when the sending party is the current user;

determining the level as the second level when the sending party is a preset user; and

determining the level as the third level when the sending party is another ordinary user.

As an example, a preset user may be an important user such as a host, a guest and a star, etc., or it may be the system itself, for example, a broadcast message sent by the system may be regarded as a message with a second level.

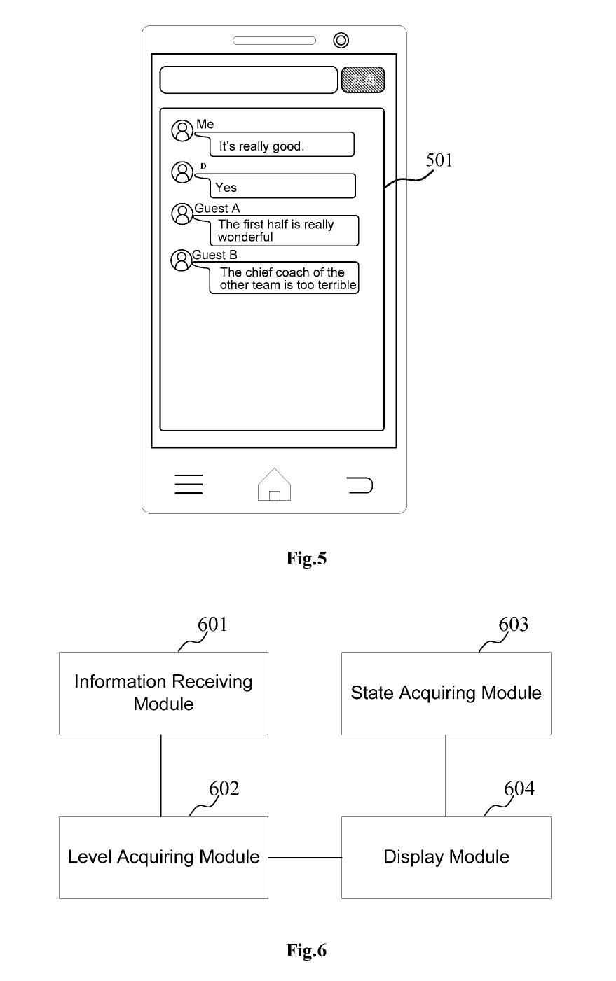

As an example, reference may be made to FIG. 5. In FIG. 5, 501 represents an information display window; the current user may see his/her own talk on the window, and may also see the words of other users such as a guest.

In this embodiment or in some other embodiments of the disclosure, the step of acquiring the level of the new information may include:

determining the level of the new information according to the level indication information carried in the new information.

In other words, except the information source, the level of the information may also be determined according to an indication contained in the information itself; for example, the information may contain a field, wherein different values of the field represents different levels of the information.

In this embodiment, levels are assigned to an information; after a terminal equipment receives a piece of new information, the terminal equipment will no longer directly display the new information, instead, it will determine a display mode based on the information level and the state of the information display window, wherein the display mode may include a direct display mode, a waiting in queue mode and a discarding mode. For example, for an information with the highest priority, such as an information sent by a user himself/herself, it wil be directly displayed; for informations with a high priority, for example, informations sent by a star\guest or broadcasted by the system, they will wait in queue and finally be displayed; however, for informations sent by other ordinary users, they may be discarded. Thus, some unimportant information may be filtered off while display of important information is guaranteed, and an overall amount of informations to be displayed is reduced; thereby it may be avoided that the display of information occupies many system resources, and the processing load on the terminal equipment may be reduced.

A device embodiment of the disclosure will be described below, which may be configured for performing the method embodiment of the disclosure. For the details not disclosed in the device embodiment of the disclosure, reference may be made to the method embodiment of the disclosure.

FIG. 6 is a block diagram of a device for displaying information according to an embodiment of the disclosure. The device may be applied to a terminal equipment such as a mobile phone and a tablet computer, etc.

Referring to FIG. 6, the device may include:

an information receiving module 601, configured for receiving a new information;

Taking a mobile phone as an example, a user may use a certain video player APP on the mobile phone to watch a video such as a direct-broadcast program; the user may participate in a chat interaction during watching, and a piece of new information may be received during chatting.

a level acquiring module 602, configured for acquiring the level of the new information;

For example, the levels could be divided into a first level, a second level and a third level, and the corresponding priorities thereof reduce gradually. It will not be limited in this embodiment how to acquire the level of the new information; for example, the level may be determined according to the information source, or be determined according to a feature carried by the information itself, etc.

a state acquiring module 603, configured for acquiring the current state of an information display window;

For example, the state of the information display window may be the state of a buffer pool. Because sometimes the terminal equipment may receive too much information in a short time period and cannot display all of the information in time, a buffer pool will be usually provided for the information display window, such that an information received first enters the buffer pool and then is displayed on the window. In the prior art, all the information received will be displayed by the terminal equipment, and the information will be buffered for a final display even if the buffer pool is full. However, in this embodiment, it will distinguish between informations based on the levels thereof, and when the buffer pool is full, some unimportant information may be directly discarded.

a display module 604, configured for determining a display mode of the new information for displaying said new information according to the level of the new information and the current state of the information display window, wherein the display mode includes a direct display mode, a waiting in queue mode and a discarding mode.

In this embodiment or in some other embodiments of the disclosure, the levels include a first level, a second level and a third level; and the current state of the information display window includes the buffer pool state of the information display window.

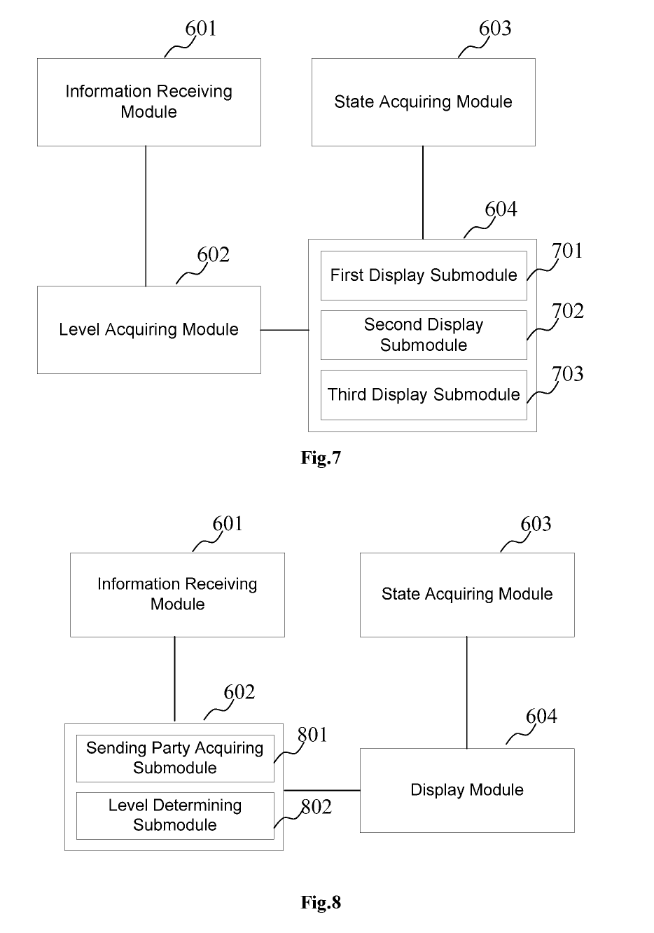

At this point, referring to FIG. 7, the display module 604 may include:

a first display submodule 701, configured for directly displaying the new information on the information display window when the level is the first level;

a second display submodule 702, configured for, when the level is the second level, adding the new information to the buffer pool if the buffer pool is not full, or waiting till the buffer pool has a free space if the buffer pool is full; and

a third display submodule 703, configured for, when the level is the third level, adding the new information to the buffer pool if the buffer pool is not full, and discarding the new information if the buffer pool is full.

Referring to FIG. 8, in this embodiment or in some other embodiments of the disclosure, the level acquiring module 602 may include:

a sending party acquiring submodule 801, configured for acquiring a sending party of the new information; and

a level determining submodule 802, configured for determining the level of the new information according to the sending party.

As an example, reference may be made to FIG. 4. In FIG. 4, 401 represents a mobile phone of the current user, 402 represents a mobile phone of a guest of a direct-broadcast program, 403 represents a server of the program providing party, and 404-406 represent mobile phones of other ordinary users. During play of the direct-broadcast program, the mobile phone 401 may receive discussion informations on the program from a guest and other users (strictly speaking, such informations are usually forwarded by a server), and the mobile phone 401 may also receive broadcast informations from the server, for example, “this program will be re-broadcasted at xx on xx”, etc. The mobile phone 401 may distinguish between the levels of each information according to different sending parties of the information.

In this embodiment or in some other embodiments of the disclosure, the level determining submodule 802 is configured for:

determining the level as the first level when the sending party is the current user;

determining the level as the second level when the sending party is a preset user; and

determining the level as the third level when the sending party is other ordinary users.

As an example, a preset user may be an important user such as a host, a guest and a star, etc., or it may be the system itself, for example, a broadcast message sent by the system may be regarded as a message with a second level.

As an example, reference may be made to FIG. 5. In FIG. 5, 501 represents an information display window; the current user may see his/her own talk on the window, and may also see the words of other users such as a guest.

In this embodiment or in some other embodiments of the disclosure, the level acquiring module 602 is configured for:

determining the level of the new information according to the level indication information carried in the new information.

In other words, except the information source, the level of the information may also be determined according to an indication contained in the information itself; for example, the information may contain a field, wherein different values of the field represents different levels of the information.

In this embodiment, levels are assigned to an information; after a terminal equipment receives a piece of new information, the terminal equipment will no longer directly display the new information, instead, it will determine a display mode based on the information level and the state of the information display window, wherein the display mode may include a direct display mode, a waiting in queue mode and a discarding mode. For example, for an information with the highest priority, such as an information sent by a user himself/herself, it wil be directly displayed; for informations with a high priority, for example, informations sent by a star\guest or broadcasted by the system, they will wait in queue and finally be displayed; however, for informations sent by other ordinary users, they may be discarded. Thus, some unimportant information may be filtered off while display of important information is guaranteed, and an overall amount of informations to be displayed is reduced; thereby it may be avoided that the display of information occupies many system resources, and the processing load on the terminal equipment may be reduced.

For the device of the above embodiment, the specific mode in which each module operates has been described in detail in the relevant method embodiments, and will not be illustrated in detail here.

It should be noted that, one embodiment of the disclosure further provides a terminal, which includes the device for displaying information according to the embodiments shown in FIG. 6 to FIG. 8.

The embodiments of the present disclosure provide a non-transitory computer-readable storage medium storing computer executable instructions that are configured to carry out a method for displaying information according to any one of the above method embodiments.

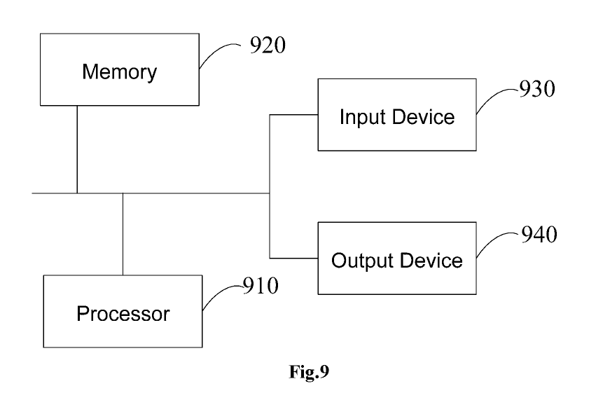

FIG. 9 is diagram illustrating a hardware structure of an apparatus for carrying out the method for displaying information according to an embodiment of the disclosure. As shown in FIG. 9, the apparatus includes:

at least one processor 910 and a memory 920, wherein only one processor 910 is illustratively shown in FIG. 9.

The apparatus executing the method for displaying information may also include: an input device 930 and an output device 940.

The processor 910, memory 920, input device 930 and output device 940 may be connected via a bus or other means, wherein a connecting bus is illustratively shown in FIG. 9.

The memory 920, as a non-volatile computer readable storage medium, may be used to store non-volatile software programs, non-volatile computer executable programs and modules, such as the program commands/modules corresponded to the method for displaying information according to the embodiments in the present disclosure. The processor 910, by running non-volatile software programs, commands and modules stored in the memory 920, performs various functional applications and data processing of the server, i.e., carries out the method for displaying information according to the above embodiments in the present disclosure.

The memory 920 may include a program storage area and a data storage area, wherein the program storage area may be used to store application programs needed by an operating system or by at least one function, and the data storage area may be used to store data created by running the device for amplifying a video image, and the like. Moreover, the memory 920 may include a high speed random access memory, and also may include a non-volatile memory, such as at least one disk memory, flash memory, or other non-volatile solid state memory. According to some embodiments, the memory 920 may optionally include memories that are remotely setup with respect to the processor 910, and these remote memories may be connected to the device for amplifying a video image via a network connection. An example of such a network includes, but not limited to, internet, intranet, local area network, mobile communication network, and a combination thereof.

The input device 930 may receive input digital or character information, and generate key signal inputs concerned with user setting and functional control of the device for amplifying a video image. The output device 940 may include displaying means such as a display screen.

The at least one module is stored in the memory 920, and, when run by the at least one processor 910, executes the method for displaying according to any one of the above method embodiments.

The above product may excite the method provided by the embodiments of the present disclosure, and has functional modules and beneficial effects corresponded to the executed method. As for technical details that are not elaborated in the present embodiments, reference can be made to the method provided by the embodiments of the present disclosure.

The electronic devices in the embodiments of the present disclosure exist in various forms, including but not limited to:

(1) mobile communication devices, characterized in having a function of mobile communication mainly aimed at providing speech and data communication, wherein such terminal includes: smart phone (such as iPhone), multimedia phone, functional phone, low end phone and the like;

(2) ultra mobile personal computer devices, which falls in a scope of personal computer, has functions of calculation and processing, and generally has characteristics of mobile internet access, wherein such terminal includes: PDA, MID and UMPC devices, such as iPad;

(3) portable entertainment devices, which can display and play multimedia contents, and includes audio or video player (such as iPod), portable game console, E-book and intelligent toys and portable vehicle navigation devices;

(4) server, a device for providing computing service, constituted by processor, hard disc, internal memory, system bus, and the like, which has a framework similar to that of a computer, but is demanded for superior processing ability, stability, reliability, security, extendibility and manageability due to that high reliable services are desired; and

(5) other electronic devices having a function of data interaction.

The above mentioned examples for the apparatus are merely exemplary, wherein the unit illustrated as a separated component may be or may not be physically separated, the component illustrated as a unit may be or may not be a physical unit, in other words, may be either disposed in some place or distributed to a plurality of network units. All or part of modules may be selected as actually required to realize the objects of the present disclosure. Such selection may be understood and implemented by ordinary skill in the art without creative work.

According to the description in connection with the above embodiments, it can be clearly understood by ordinary skill in the art that various embodiments can be realized by means of software in combination with necessary universal hardware platform, and certainly, may further be realized by means of hardware. Based on such understanding, the above technical solutions in substance or the part thereof that makes a contribution to the prior art may be embodied in a form of a software product which can be stored in a computer-readable storage medium, such as ROM/RAM, magnetic disk and compact disc, and includes several instructions for allowing a computer apparatus (which may be a personal computer, a server, a network device or the like) to execute the methods described in various embodiments or some parts thereof.

Other implementation solutions of the invention may easily occur to one skilled in the art after considering the specification and practicing the invention disclosed herein. This application intends to cover any variations, usage or adaptability changes of the invention, which comply with the general principles of the invention and include well-known common sense or conventional technical measures in the art that are not disclosed herein. The specification and embodiments are exemplary only, and the true scope and spirit of the invention are defined by the claims appended.

It should be understood that, the disclosure is not limited to the exact structure described above and shown in the drawings, and various modifications and variations may be made without departing from the scope of the disclosure. Therefore, the scope of the disclosure is only defined by the claims appended.

Finally, it should be stated that, the above embodiments are merely used for illustrating the technical solutions of the present disclosure, rather than limiting them. Although the present disclosure has been illustrated in details in reference to the above embodiments, it should be understood by ordinary skill in the art that some modifications can be made to the technical solutions of the above embodiments, or part of technical features can be substituted with equivalents thereof. Such modifications and substitutions do not cause the corresponding technical features to depart in substance from the spirit and scope of the technical solutions of various embodiments of the present disclosure.

What is claimed is:

1. A method for displaying information applied to an electronic device, comprising:
receiving a new information;
acquiring a level of the new information;
acquiring a current state of an information display window; and
determining a display mode of the new information for displaying the new information according to the level of the new information and the current state of the information display window, wherein the display mode comprises a direct display mode, a waiting in queue mode and a discarding mode.

2. The method according to claim 1, wherein the level comprises a first level, a second level and a third level; and the current state of the information display window comprises a buffer pool state of the information display window;
the step of the determining the display mode of the new information according to the level of the new information and the current state of the information display window comprises:
directly displaying the new information on the information display window if the level is the first level;
if the level is the second level or the third level, then
determining whether the buffer pool is full;
adding the new information to the buffer pool if the buffer pool is not full;
waiting till the buffer pool has a free space if the buffer pool is full and the level is the second level; and
discarding the new information if the buffer pool is full and the level is the third level.

3. The method according to claim 1, wherein the step of acquiring the level of the new information comprises:
acquiring a sending party of the new information; and
determining the level of the new information according to the sending party.

4. The method according to claim 3, wherein the step of determining the level of the new information according to the sending party comprises:
determining the level as the first level when the sending party is the current user;
determining the level as the second level when the sending party is a preset user; and
determining the level as the third level when the sending party is another ordinary user.

5. The method according to claim 1, wherein the step of acquiring the level of the new information comprises:
determining the level of the new information according to a level indication information carried in the new information.

6. A non-transitory computer-readable storage medium storing computer executable instructions that, when executed by an electronic device, cause the electronic device to:
receive a new information;
acquire a level of the new information;
acquire a current state of an information display window; and
determine a display mode of the new information for displaying the new information according to the level of the new information and the current state of the information display window, wherein the display mode comprises a direct display mode, a waiting in queue mode and a discarding mode.

7. The non-transitory computer-readable storage medium according to claim 6, wherein the level comprises a first level, a second level and a third level; and the current state of the information display window comprises a buffer pool state of the information display window;
the instructions to determine the display mode of the new information according to the level of the new information and the current state of the information display window cause the electronic device to:
directly display the new information on the information display window if the level is the first level;
if the level is the second level or the third level, then
determine whether the buffer pool is full;
add the new information to the buffer pool if the buffer pool is not full;
wait till the buffer pool has a free space if the buffer pool is full and the level is the second level; and
discard the new information if the buffer pool is full and the level is the third level.

8. The non-transitory computer-readable storage medium according to claim 6, wherein the instructions to acquire the level of the new information cause the electronic device to:
acquire a sending party of the new information; and
determine the level of the new information according to the sending party.

9. The non-transitory computer-readable storage medium according to claim 8, wherein the instructions to determine the level of the new information according to the sending party cause the electronic device to:
determine the level as the first level when the sending party is the current user;
determine the level as the second level when the sending party is a preset user; and
determine the level as the third level when the sending party is another ordinary user.

10. The non-transitory computer-readable storage medium according to claim 6, wherein the instructions to acquire the level of the new information cause the electronic device to:
determine the level of the new information according to a level indication information carried in the new information.

11. An electronic device, comprising:
at least one processor; and
a memory communicably connected with the at least one processor and for storing instructions executable by the at least one processor, wherein execution of the instructions by the at least one processor causes the at least one processor to receive a new information;
acquire a level of the new information;
acquire a current state of an information display window; and
determine a display mode of the new information for displaying the new information according to the level of the new information and the current state of the information display window, wherein the display mode comprises a direct display mode, a waiting in queue mode and a discarding mode.

12. The electronic device according to claim 11, wherein the level comprises a first level, a second level and a third level; and the current state of the information display window comprises a buffer pool state of the information display window;
wherein the execution of the instructions to determine the display mode of the new information according to the level of the new information and the current state of the information display window causes the at least one processor to:
directly display the new information on the information display window if the level is the first level;
if the level is the second level or the third level, then
determine whether the buffer pool is full;
add the new information to the buffer pool if the buffer pool is not full;
wait till the buffer pool has a free space if the buffer pool is full and the level is the second level; and
discard the new information if the buffer pool is full and the level is the third level.

13. The electronic device according to claim 11, wherein the execution of the instructions to acquire the level of the new information causes the at least one processor to:
acquire a sending party of the new information; and
determine the level of the new information according to the sending party.

14. The electronic device according to claim 13, wherein the execution of the instructions to determine the level of the new information according to the sending party causes the at least one processor to:
determine the level as the first level when the sending party is the current user;
determine the level as the second level when the sending party is a preset user; and
determine the level as the third level when the sending party is another ordinary user.

15. The electronic device according to claim 11, wherein the execution of the instructions to acquire the level of the new information causes the at least one processor to:
determine the level of the new information according to a level indication information carried in the new information.
